(19) United States
(12) Patent Application Publication
(10) Pub. No.: US 2011/0316675 A1
(43) Pub. Date: Dec. 29, 2011

(54) APPARATUS FOR COMMUNICATING WTIH RFID TAG

(75) Inventors: Yoshiyuki TSUJIMOTO, Nagoya-shi (JP); Takuya Nagai, Nagoya-shi (JP)

(73) Assignee: BROTHER KOGYO KABUSHIKI KAISHA, Nagoya-shi (JP)

(21) Appl. No.: 13/228,655

(22) Filed: Sep. 9, 2011

Related U.S. Application Data
(63) Continuation-in-part of application No. PCT/JP2010/052949, filed on Feb. 25, 2010.

(30) Foreign Application Priority Data
Mar. 30, 2009 (JP) 2009-081081

(51) Int. Cl. H04Q 5/22

(52) U.S. Cl. 340/10.4

(57) ABSTRACT

The disclosure discloses an apparatus comprising: an apparatus antenna; a signal transmitting portion configured to transmit a response request signal; an information obtainment portion configured to obtain tag identification information of the RFID tag circuit element; an identification information storage portion configured to store the tag identification information obtained; a calculation portion configured to calculate a duplicated obtainment ratio by the number of redundantly obtained pieces of information of a current obtainment result of the tag identification information to a past obtainment result of the tag identification information stored in the identification information storage portion and by the obtainment result; a comparison portion configured to compare the duplicated obtainment ratio with a threshold value; and a communication control portion configured to execute communication control of widening or narrowing a communication range in the case that the duplicated obtainment ratio is less than or exceeds the threshold value.

### CROSS-REFERENCE TO RELATED APPLICATION

This is a CIP application PCT/JP2010/052949, filed Feb. 25, 2010, which was not published under PCT article 21(2) in English.

### BACKGROUND OF THE INVENTION

1. Field of the Invention

The present invention relates to an apparatus for communicating with a radio frequency identification (RFID) tag that can perform radio communication of information with the outside and performs information reading.

2. Description of the Related Art

Recently, a Radio Frequency Identification (hereinafter referred to as RFID) system has been proposed as one of radio communication systems that perform radio communication with a communication target. In the RFID system, information reading and writing is performed in a non-contact manner between an RFID tag circuit element provided with an IC circuit part that stores information and a tag antenna that can perform information transmission and reception and a reader/writer, which is a reading device and writing device.

In prior-art references in which this RFID system is applied to inventory-taking, when the inventory is taken, in order to obtain tag identification information from a plurality of RFID tag circuit elements without fail, a response request signal is repeatedly transmitted from the apparatus for communicating with an RFID tag while moving in a communication range. Then, from a response signal corresponding to the response request signal, the tag identification information is repeatedly obtained by the apparatus for communicating with an RFID tag. As a result, missed transmission occurring at an RFID tag circuit element to which the response request signal does not reach or missed reception causing a state in which even if the response request signal from the RFID tag circuit element reaches, the response signal cannot be received is prevented from occurring.

However, in repeated transmission of the response request signal, it is a useless operation to redundantly obtain tag identification information again from the RFID tag circuit element which has once received the response signal and obtained the tag identification information, and power is wasted.

### SUMMARY OF THE INVENTION

An object of the present invention is to provide an apparatus for communicating with an RFID tag that can prevent power from being wasted while avoiding missed transmission or missed reception.

In order to achieve the above-mentioned object, according to the invention, there is provided an apparatus for communicating with a radio frequency identification (RFID) tag configured to perform radio communication with an RFID tag circuit element having an IC circuit part that stores information and a tag antenna that performs information transmission and reception, the apparatus comprising: an apparatus antenna configured to form a communication range where a radio communication is able to be performed and performs radio communication with the RFID tag circuit element located in the communication range; a signal transmitting portion configured to transmit a response request signal to the RFID tag circuit element by the apparatus antenna; an information obtainment portion configured to obtain tag identification information stored in the IC circuit part of the RFID tag circuit element from a response signal transmitted from the RFID tag circuit element in response to the response request signal and received by the apparatus antenna; an identification information storage portion configured to store the tag identification information obtained by the information obtainment portion; a calculation portion configured to calculate a duplicated obtainment ratio by the number of redundantly obtained pieces of information of a current obtainment result of the tag identification information by the information obtainment portion to a past obtainment result of the tag identification information stored in the identification information storage portion and by the obtainment result; a comparison portion configured to compare the duplicated obtainment ratio calculated by the calculation portion with a threshold value for comparison; and a communication control portion configured to execute communication control of widening a communication range of the apparatus antenna in at least the case that the duplicated obtainment ratio is less than the threshold value for comparison and of narrowing the communication range of the apparatus antenna in at least the case that the duplicated obtainment ratio exceeds the threshold value for comparison on the basis of a comparison result by the comparison portion.

### BRIEF DESCRIPTION OF THE DRAWING

FIG. 1 is a diagram illustrating an example of an RFID tag communication system using an apparatus for communicating with an RFID tag according to an embodiment of the present invention being applied to management of articles.

FIG. 2 is a system configuration diagram illustrating an outline of a reader and an RFID tag used in this embodiment.

FIG. 3 is an explanatory diagram illustrating an example in which a communication power is not increased or decreased but maintained the same.

FIG. 4 is an explanatory diagram illustrating an example in which the communication power is reduced.

FIG. 5 is an explanatory diagram illustrating an example in which the communication power is increased.

FIG. 6 is an explanatory diagram illustrating an example in which the communication power is controlled to the maximum.

FIG. 7 is a flowchart illustrating control procedures executed by a CPU of the reader.

FIG. 8 is an explanatory diagram for explaining a half-band width in a variation in which a threshold value is set on the basis of directivity of a reader antenna.

FIG. 9 is an explanatory diagram illustrating an example in which the half-band width of the reader antenna is relatively wide.

FIG. 10 is an explanatory diagram illustrating an example in which the half-band width of the reader antenna is relatively narrow.

FIG. 11 is a table used for setting the threshold value by the directivity of the reader antenna.

FIG. 12 is a flowchart illustrating the control procedures executed by the CPU of the reader.

FIG. 13 is a flowchart illustrating the control procedures executed by the CPU of the reader in a variation in which the threshold value is changed in accordance with directivity variable control of the reader antenna.

FIG. 14 is a table used in a variation in which the threshold value is set in accordance with the number of obtained tag IDs.

FIG. 15 is a flowchart illustrating the control procedures executed by the CPU of the reader.

FIG. 16 is an explanatory diagram illustrating a state in which duplicated obtainment of the tag ID occurs in communication ranges vertically adjacent to the reader antenna.

FIG. 17 is an explanatory diagram illustrating a state in which duplicated obtainment of the tag ID occurs in communication ranges vertically adjacent to the reader antenna.

### DETAILED DESCRIPTION OF THE PREFERRED EMBODIMENT

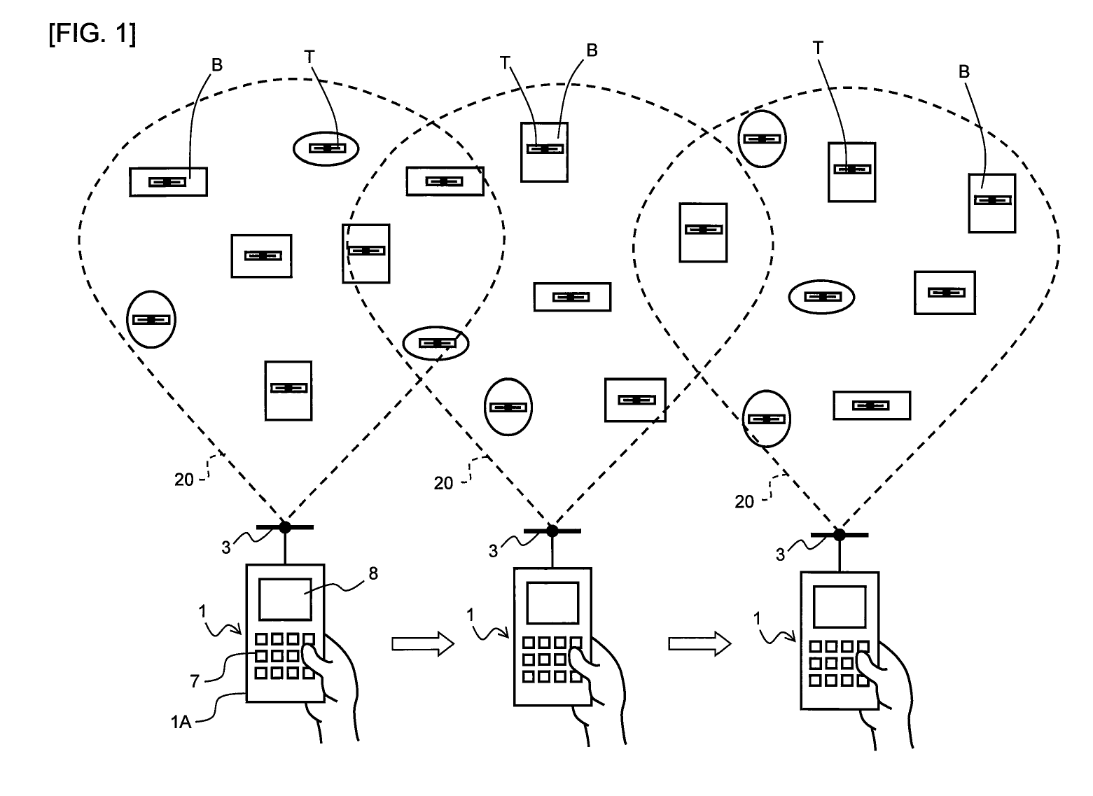

As illustrated in FIG. 1, in this embodiment, an RFID tag T is attached to each of a large number of articles B.

A reader 1, which is an apparatus for communicating with an RFID tag in this embodiment, is a handheld type and has a substantially rectangular solid housing 1A. On the housing 1A, a reader antenna 3 as an apparatus antenna is disposed on one of end portions in the longitudinal direction. On a plane portion of the hosing 1A, an operation part 7 and a display part 8 are disposed.

A user, that is, an operator of the reader 1 is a manager of the articles B. The reader 1 used by the user reads tag information relating to the article B from the RFID tag T attached to each of the articles B through radio communication. The user manages storage situation of each of the articles B by the read-out tag information.

A communication range 20 in which the reader 1 is capable of radio communication is a region expanded from the reader antenna 3 as a base point. The size of the communication range 20 is limited in accordance with the directivity of the reader antenna 3 or power of the reader antenna 3, that is, antenna power. Thus, the user moves the communication range 20 of a communication wave emitted from the reader antenna 3 by the reader 1. The reader 1 performs information reading from the RFID tag T while moving. The reader 1 repeatedly transmits a response request signal of the RFID tag T while moving, receives a response signal from the RFID tag T, and repeatedly obtains the tag ID from the response signal. As a result, missed transmission which causes an RFID tag T not reached by the response request signal or missed reception which causes a state in which even if the response request signal reaches the RFID tag T, the response signal cannot be received by the reader 1 can be suppressed.

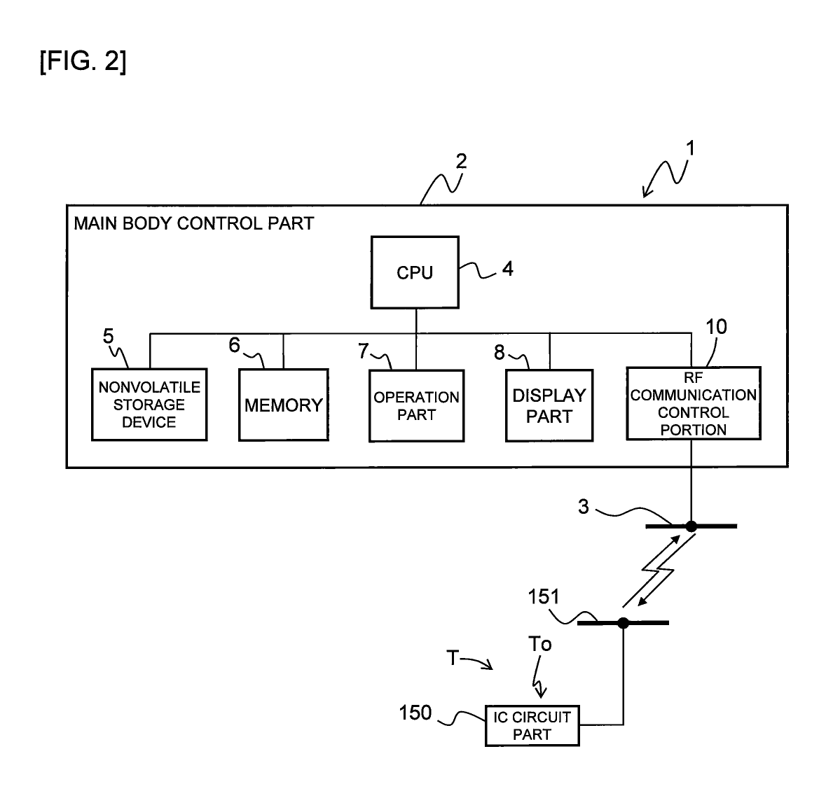

As illustrated in FIG. 2, the RFID tag T has an RFID tag circuit element To provided with a tag antenna 151 and an IC circuit part 150 and can be attached to the article B. The RFID tag circuit element To is disposed on a base material provided in the RFID tag T. The RFID tag circuit element To is provided with a function as a passive tag. The RFID tag circuit element To receives a response request signal from the reader 1. The RFID tag circuit element To transmits a response signal including the tag ID, which is tag identification information, in response to the received response request signal to the reader 1. The tag antenna 151 is a die-pole antenna having a substantially linear shape in the entirety in this example. The longitudinal direction of the tag antenna 151 is a direction where a polarization plane is formed.

The reader 1 has a main-body control part 2 and the reader antenna 3. The main-body control part 2 has a CPU 4, a nonvolatile storage device 5, a memory 6, the operation part 7, the display part 8 as informing means, and a radio frequency (RF) communication control part 10.

The nonvolatile storage device 5 is formed of a hard disk device or flash memory. The nonvolatile storage device 5 stores various types of information such as communication parameters relating to radio communication of the reader 1 and management state of the articles B.

The memory 6 is formed of a RAM and a ROM, for example. Into the operation part 7, instructions and information from the user are inputted. The display part 8 displays various types of information and messages.

The reader antenna 3 is a so-called die-pole antenna having a substantially linear shape in the entirety, for example. In this example, the longitudinal direction of the reader antenna 3 is in parallel with the width direction of the housing 1A of the reader 1. The longitudinal direction of the reader antenna 3 is an electric field plane of the radio wave from the reader antenna 3, that is, a polarization plane direction. As the reader antenna 3, an antenna in the form such as a micro-strip antenna may be used. The reader antennas in the other forms have their polarization plane directions controlled by a direction in which an electric current flows.

The RF communication control part 10 executes control of radio communication with the RFID tag T through the reader antenna 3. The RF communication control part 10 makes an access to the RFID tag information including the tag ID, which is the information stored in the IC circuit part 150 of the RFID tag circuit element To.

The CPU 4 performs signal processing according to a program stored in the ROM in advance while using a temporary storage function of the RAM and executes various controls of the entire reader 1. The CPU 4 processes a signal read of the IC circuit part 150 of the RFID tag circuit element To so as to read information and generates various commands in order to access the IC circuit part 150 of the RFID tag circuit element To.

One of the features of this embodiment is that the reader 1 obtains a duplicated obtainment ratio W to the plurality of tag IDs obtained similarly in the communication range 20 immediately before every time the tag ID is obtained from each of the plurality of RFID tags T in each of the communication ranges 20 to be moved. If the duplicated obtainment ratio W is larger than a predetermined threshold value th, it is regarded that the size of the communication range 20 in the moving direction is larger than necessary, and the communication power radiated from the reader antenna 3 is reduced. The size of the communication range 20 in the moving direction is referred to as a unit “communication range” below as appropriate. If the duplicated obtainment ratio W is smaller than the predetermined threshold value th, it is regarded that the communication range is too narrow to prevent missed transmission or missed reception, and the communication power radiated from the reader antenna 3 is increased.

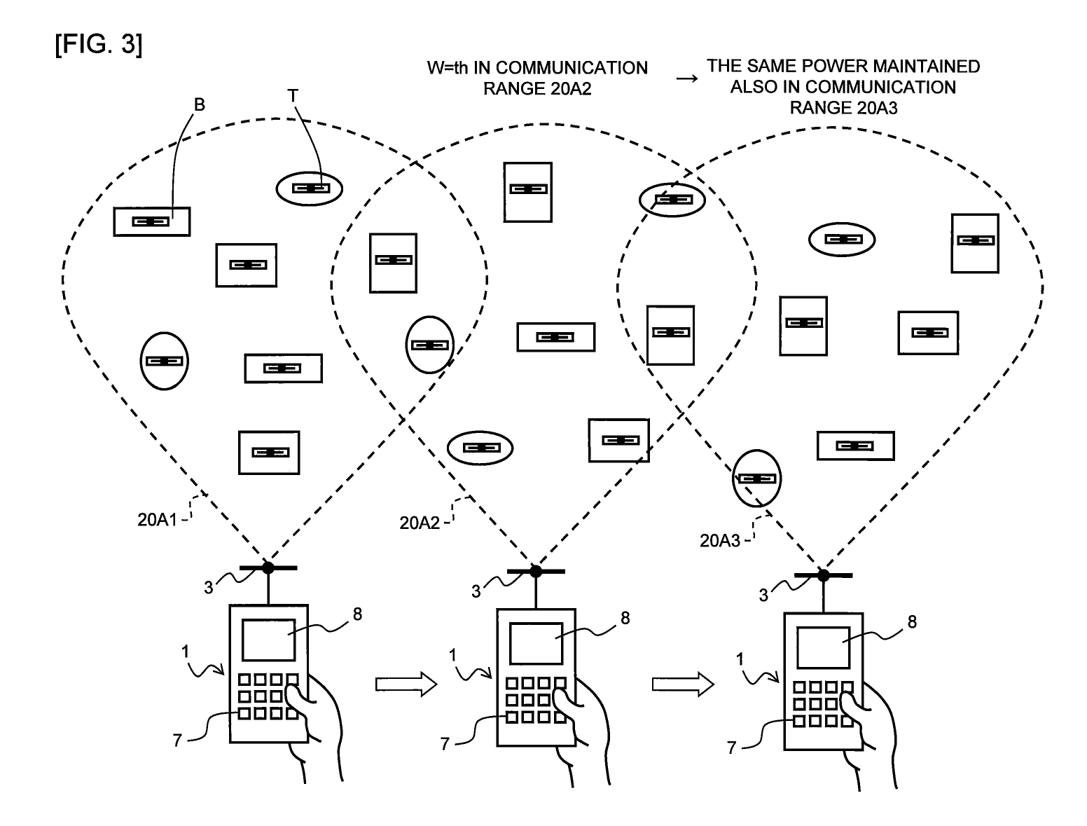

In examples in FIGS. 3 to 6 for explaining various examples of increase and decrease control of the communication power as described above, the example in which the threshold value th of the duplicated obtainment ratio W as a threshold value for comparison which is appropriate for preventing missed transmission or missed reception is set to 0.25 will be described.

(A) Example in which Communication Power is not Increased and Decreased but Maintained the Same

In the example illustrated in FIG. 3, for example, first, the reader 1 forms a communication range 20A1 from the reader antenna 3 by a predetermined communication power. The reader 1 transmits a response request signal as an inquiry request signal to the plurality of RFID tags T in the communication range 20A1. If a response signal is transmitted from each of the RFID tags T in the communication range 20A1 in response to the response request signal, the reader 1 obtains the respective tag IDs from the tag information included in the transmitted response signal. In this case, if there are eight RFID tags T in the communication range 20A1 as illustrated, eight tag IDs are obtained by the reader 1.

After that, the user moves the reader 1 as described above, and the reader 1 forms a communication range 20A2 from the reader antenna 3 by the same communication power as the above. The communication range 20A2 in this case has substantially the same size as that of the communication range 20A1. Similarly to the above, the reader 1 transmits a response request signal to the plurality of RFID tags T in the communication range 20A2 and obtains the respective tag IDs from the response signal from each of the RFID tags T in the communication range 20A2. In this case, there are eight RFID tags T in the communication range 20A2 as illustrated, and eight tag IDs are obtained by the reader 1. Among the eight RFID tags T from which the tag IDs are obtained, two RFID tags T are RFID tags T also located in the communication range 20A1 immediately before. The two RFID tags T are located in duplication in both the communication range 20A1 and the communication range 20A2. Therefore, the number of tag IDs obtained in the communication range 20A2 is eight, and the number of redundantly obtained tag IDs in the communication ranges 20A1 and 20A2 is two, which makes the duplicated obtainment ratio W of the tag ID is W=2/8=0.25 and W=th. Thus, the reader 1 does not increase or decrease the communication power in accordance with this result but maintains the same power.

If the user further moves the reader 1, the reader 1 forms a communication range 20A3 from the reader antenna 3 by the communication power maintained the same as described above. The communication range 20A3 has substantially the same size as that of the communication range 20A2. Similarly to the above, eight tag IDs are obtained by the reader 1 from the eight RFID tags T present in the communication range 20A3. Then, among the eight RFID tags T, two RFID tags T are located also in the communication range 20A2 immediately before. Therefore, the number of tag IDs obtained in the communication range 20A3 is 8, and the number of obtained tags ID in duplication in the communication ranges 20A2 and 20A3 is two, which makes the duplicated obtainment ratio W of the tag ID of W=2/8=0.25 and W=th. Thus, the reader 1 does not increase and decrease the communication power in accordance with this result but maintains the same power.

(B) Example in which Communication Power is Subjected to Decrease Control

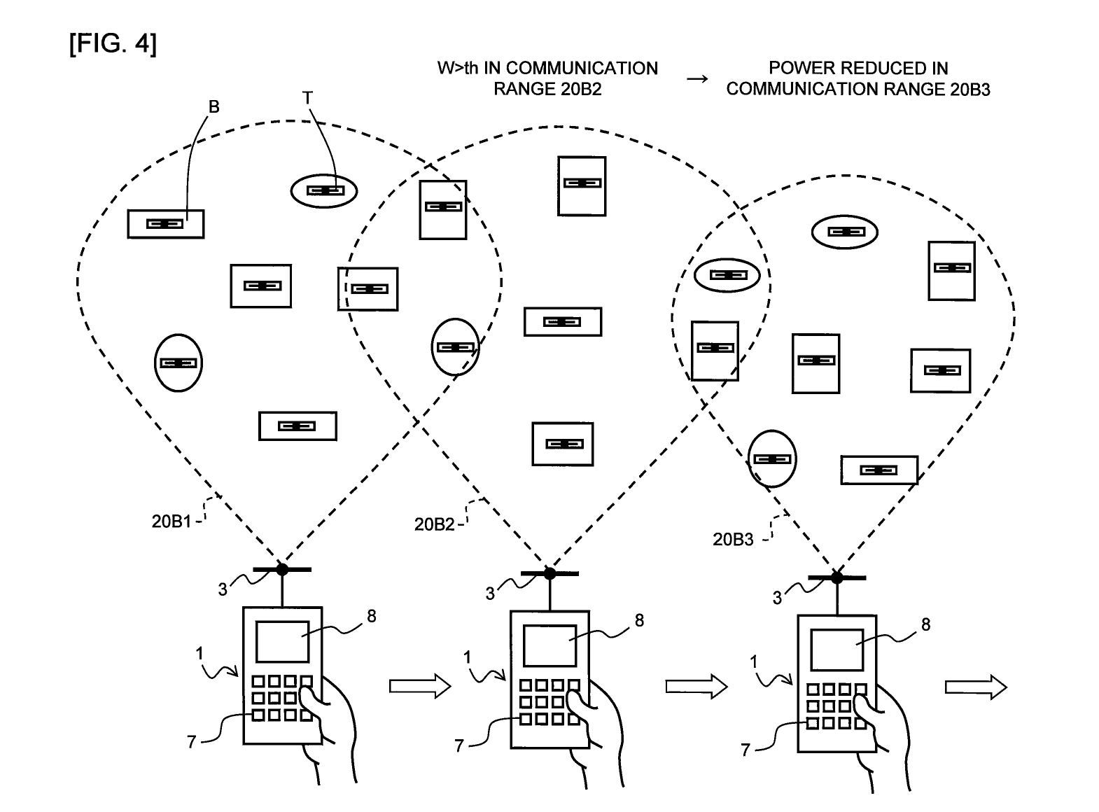

In the example illustrated in FIG. 4, first, the reader 1 forms a communication range 20B1 form the read antenna 3 by a predetermined communication power. Similarly to the above, the reader 1 transmits a response request signal to the plurality of RFID tags T in the communication range 20B1 and obtains the respective tag IDs from the response signal from each of the RFID tags T in the communication range 20B1. As illustrated, there are eight RFID tags T in the communication range 20B1, and eight tag IDs are obtained by the reader 1.

After that, the user moves the reader 1, and the reader 1 forms a communication range 20B2 by the same communication power as the above. The communication range 20B2 has the substantially same size as that of the communication range 20B1. Similarly to the above, the reader 1 transmits a response request signal to the plurality of RFID tags T in the communication range 20B2 and obtains the tag ID from each of the RFID tags T. As illustrated, there are eight RFID tags T in the communication range 20B2 and eight tag IDs are obtained. In this example, three RFID tags T among the eight RFID tags T are located also in the communication range 20B1 immediately before. That is, the three RFID tags T are located redundantly in both the communication range 20B1 and the communication range 20B2. Therefore, the number of tag IDs obtained in the communication range 20B2 is 8, and the number of redundantly obtained tag IDs in the communication ranges 20B1 and 20B2 is three, which makes the duplicated obtainment ratio W of the tag ID is W=3/8=0.375 and W>th. Thus, it is regarded that the communication power is wasted, and control of reducing the communication power from the reader antenna 3 is executed.

As a result, if the user further moves the reader 1, the reader 1 forms a communication range 20B3 from the reader antenna 3 by the communication power reduced as above. The communication range 20B3 is smaller than the communication range 20B2. In this example, eight tag IDs are obtained by the reader 1 from the eight RFID tags T present in the communication range 20B3.

The two RFID tags T among the eight RFID tags T from which the tag IDs are obtained are the RFID tags T located also in the communication range 20B2 immediately before. Since the number of tag IDs obtained in the communication range 20B3 is eight, and the number of obtained tag IDs in duplication in the communication ranges 20B2 and 20B3 is two, the duplicated obtainment ratio W of the tag ID is W=2/8=0.25 and W=th. Thus, similarly to the case illustrated in FIG. 3 in which the communication range A2 is formed, the reader 1 does not increase and decrease the communication power in accordance with the result and the communication power is maintained the same.

(C) Example in which Communication Power is Subjected to Increase Control

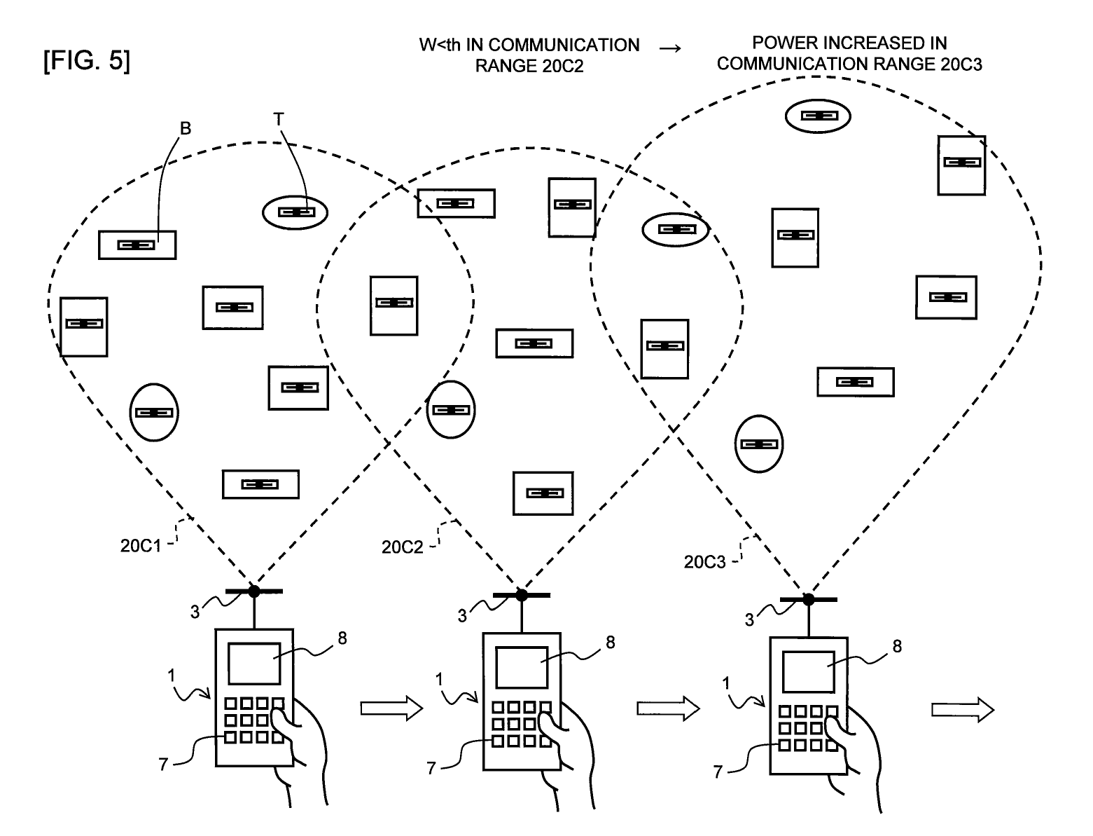

In an example illustrated in FIG. 5, first, the reader 1 forms a communication range 20C1 from the reader antenna 3 by a predetermined communication power. Similarly to the above, the reader 1 transmits a response request signal to the plurality of RFID tags T in the communication range 20C1 and obtains the respective tag IDs from the response signal from each of the RFID tags T in the communication range 20C1. As illustrated, there are eight RFID tags T in the communication range 20C1, and eight tag IDs are obtained by the reader 1.

After that, the user moves the reader 1, and a communication range 20C2 is formed by the same communication power as the above. The communication range 20C2 has substantially the same size as that of the communication range 20C1. Similarly to the above, the reader 1 transmits a response request signal to the plurality of the RFID tags T in the communication range 20C2 and obtains the tag ID from each of the RFID tags T. As illustrated, there are eight RFID tags T in the communication range 20C2, and eight tag IDs are obtained by the reader 1. In this example, one RFID tag T among the eight RFID tags T is the RFID tag T located also in the communication range 20C1 immediately before. That is, eight RFID tags T are located redundantly in both the communication range 20C1 and the communication range 20C2. Therefore, the number of tag IDs obtained in the communication range 20C2 is 8, and the number of redundantly obtained tag IDs in the communication ranges 20C1 and 20C2 is one, which makes the duplicated obtainment ratio W of the tag ID is W=1/8=0.125 and W<th. Thus, the reader 1 considers that there is a concern of missed transmission or missed reception, and control of increasing the communication power from the reader antenna 3 is executed.

As a result, if the user further moves the reader 1, the reader 1 forms a communication range 20C3 from the reader antenna 3 by the communication power increased as above. The communication range 20C3 is larger than the communication range 20C2. In this example, eight tag IDs are obtained by the reader 1 from the eight RFID tags T present in the communication range 20C3.

Among the eight RFID tags T from which the tag IDs are obtained, two RFID tags T are RFID tags T located also in the communication range 20C2 immediately before. Since the number of tag IDs obtained in the communication range 20C3 is 8, and the number of redundantly obtained tag IDs in the communication ranges 20C2 and 20C3 is two, the duplicated obtainment ratio W of the tag ID is W=2/8=0.25 and W=th. Thus, similarly to the above, increase or decrease of the communication power by the reader 1 in accordance with the result is not performed but the same power is maintained.

(D) Example in which Communication Power is Subjected to Maximum Control

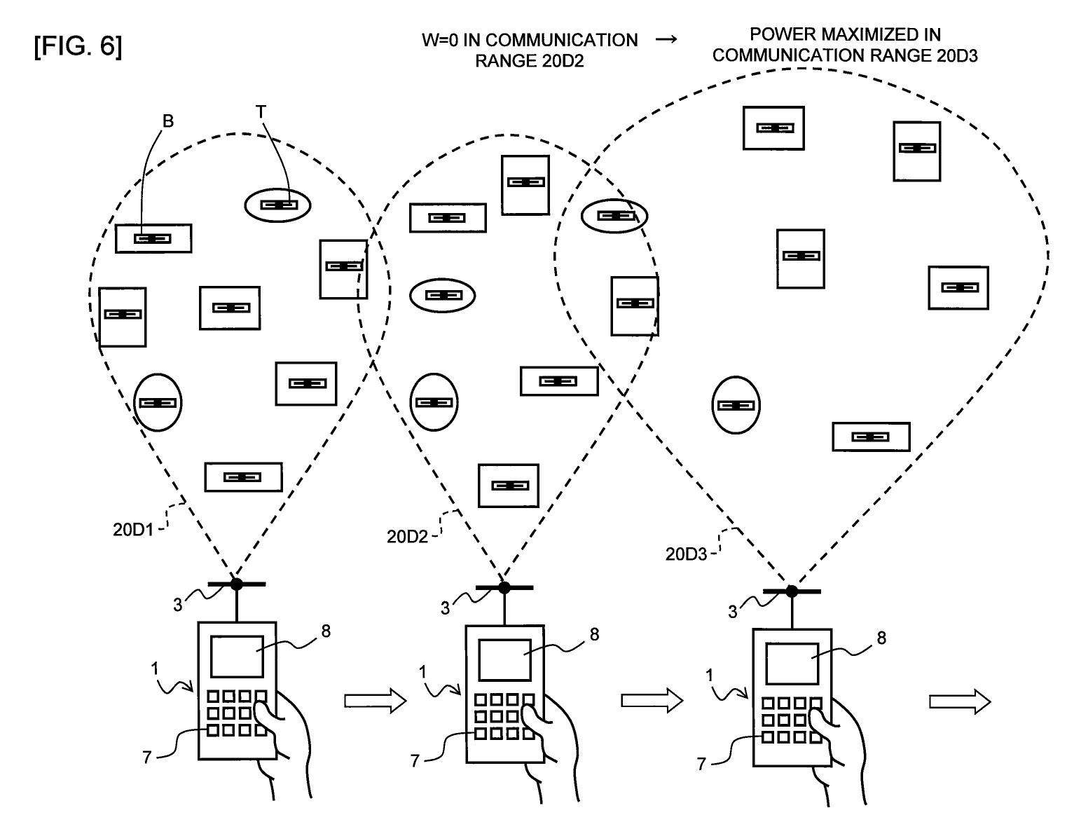

In an example illustrated in FIG. 6, first, the reader 1 forms a communication range 20D1 from the reader antenna 3 by a predetermined communication power. Similarly to the above, the reader 1 transmits a response request signal to the plurality of RFID tags T in the communication range 20D1 and obtains the tag ID from the response signal from each of the RFID tags T in the communication range 20D1. As illustrated, there are eight RFID tags T in the communication range 20D1, and eight tag IDs are obtained by the reader 1.

After that, the user moves the reader 1, and the reader 1 forms a communication range 20D2 by the same communication power as the above. The communication range 20D2 has substantially the same size as that of the communication range 20D1. Similarly to the above, the reader 1 transmits a response request signal to the plurality of RFID tags T in the communication range 20D2 and obtains the respective tag IDs from each of the RFID tags T. As illustrated, there are eight RFID tags T in the communication range 20D2, and eight tag IDs are obtained by the reader 1. In this example, there is no RFID tag T also located in the communication range 20D1 immediately before. That is, there is no RFID tag T located redundantly in both the communication range 20D1 and the communication range 20D2. Therefore, the number of tag IDs obtained in the communication range 20D2 is eight, and the number of redundantly obtained tag IDs in the communication ranges 20D1 and 20D2 is zero, which makes the duplicated obtainment ratio W of the tag ID is W=0. In this case, the reader 1 considers that there is a strong concern that missed transmission or missed reception can occur, and control of making the communication power from the reader antenna 3 to the maximum value is executed. This maximum value is an upper limit value allowed in light of performances of the reader 1.

As a result, if the user further moves the reader 1, the reader 1 forms a commination range 20D3 from the reader antenna 3 by the communication power which becomes the maximum value as described above. The communication range 20D3 is the maximum communication range that can be formed by the reader 1. In this example, eight tag IDs are obtained by the reader 1 from the eight RFID tags T present in the communication range 20D3.

Among the eight RFID tags T from which the tag IDs are obtained, two RFID tags T are RFID tags T located also in the communication range 20D2 immediately before. Since the number of tag IDs obtained in the communication range 20D3 is eight, and the number of obtained tag IDs in duplication in the communication ranges 20D2 and 20D3 is two, the duplicated obtainment ratio W of the tag ID is W=2/8=0.25 and W=th. Thus, similarly to the above, increase or decrease of the communication power by the reader 1 in accordance with the result is not performed but the same power is maintained.

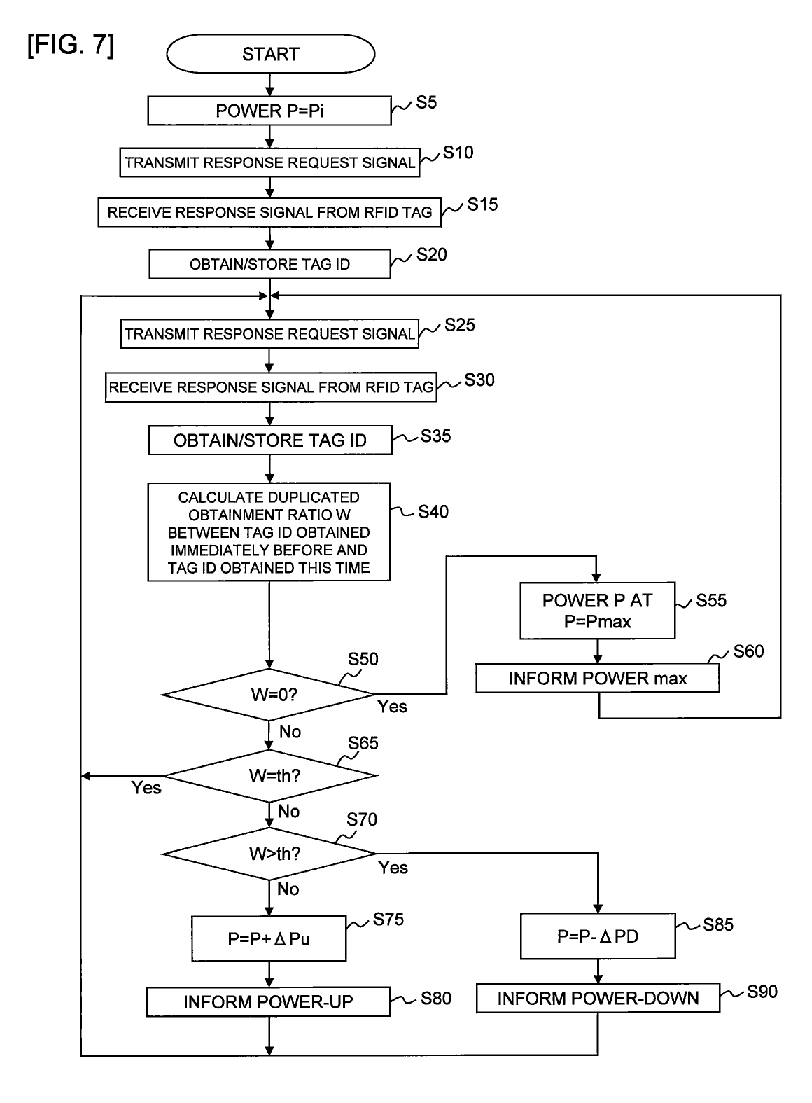

Control procedures of the CPU 4 which realize an operation in a form illustrated in FIGS. 3 to 6 will be described by referring to FIG. 7.

In FIG. 7, after the reader 1 is powered on, for example, processing is started. The processing may be started when an operation to start the reading processing of the RFID tag T is executed in the operation part 7, for example.

At Step S5, the CPU 4 outputs a control signal to the RF communication control part 10 and sets the magnitude of a communication power P radiated from the reader antenna 3 to a predetermined initial value Pi. The initial value Pi may be a maximum value Pmax, which will be described later.

At Step S10, the CPU 4 transmits a response request signal to the RFID tag circuit elements To of the plurality of RFID tags T located in the communication range 20 through the RF communication control part 10 and the reader antenna 3.

At Step S15, the CPU 4 receives a response signal transmitted from the RFID tag circuit element 10 in response to the response request signal through the reader antenna 3 and the RF communication control part 10. At Step S20, the CPU 4 extracts and obtains the tag ID from tag information included in the received response signal and has the obtained tag ID stored in the memory 6.

At step S25, the CPU 4 transmits a response request signal to the RFID tag circuit elements To of the plurality of RFID tags T located in the communication range 20 similarly to Step S10. This procedure by the CPU 4 functions as signal sending means. At Step S30, the CPU 4 receives a response signal transmitted from the RFID tag circuit element To in response to the response request signal similarly to Step S15. At Step S35, the CPU 4 extracts and obtains the tag ID similarly to Step S20. This procedure by the CPU 4 functions as information obtainment means. At Step S35, the CPU 4 has the obtained tag ID stored in the memory 6. This procedure by the CPU 4 functions as identification information storing means.

At Step S40, the duplicated obtainment ratio W [number of redundantly obtained tag IDs]/[number of tag IDs obtained this time] between the tag IDs obtained immediately before and the tag IDs obtained this time is calculated. This procedure by the CPU 4 functions as calculating means. The tag ID obtained immediately before is the tag ID obtained at Step S20 and stored in the memory 6. Alternatively, if the routine returns to Step S25 from the Step S60, Step S80, and Step S90, which will be described later, the tag ID obtained immediately before is the tag ID obtained at Step S35 before the return and stored in the memory 6. Also, the tag ID obtained this time is the tag ID obtained at Step S35.

At Step S50, the CPU 4 determines whether or not the duplicated obtainment ratio W of the tag ID calculated at Step S40 is 0. If it is W=0, the determination is satisfied, and the routine proceeds to Step S55.

At Step S55, the CPU 4 considers that the communication power P radiated from the reader antenna 3 is small, and there is no duplicated obtainment between the tag ID obtained immediately before and the tag ID obtained this time. The CPU 4 changes the communication power P to the maximum value Pmax in light of the performances of the reader 1. At Step S60, the CPU 4 outputs a signal to the display part 8 so as to have the display part display and inform the user that the communication power P is changed to Pmax. The CPU 4 returns to Step S25 and repeats the similar procedures.

At Step S50, if the duplicated obtainment ratio W of the tag ID calculated at Step S40 is not zero, the determination at Step S50 is not satisfied, and the routine proceeds to Step S65.

At Step S65, the CPU 4 determines whether or not it is W=th. If the duplicated obtainment ratio W is equal to the threshold value th, the determination is satisfied, and the CPU 4 considers that the communication power has an appropriate magnitude, returns to Step S25, and repeats the similar procedures. That is, the control including the flow to return from Step S65 to Step S25 corresponds to transition from the communication range 20A2 to the communication range 20A3 in FIG. 3. On the other hand, at Step S65, if it is W≠th, the determination is not satisfied, and the routine proceeds to Step S70.

At Step S70, the CPU 4 determines whether or not it is W>th. If the duplicated obtainment ratio W is smaller than the threshold value th of the duplicated obtainment ratio, the determination is not satisfied, and the CPU 4 considers that the communication power is small and proceeds to Step S75. At Step S75, the CPU 4 increases the communication power P only by ΔPu, which is a first power width. At Step S80, the CPU 4 outputs a signal to the display part 8 so as to have the display part 8 display and inform the user that the communication power P has been increased and then, returns to Step S25 and repeats the similar procedures. That is, the control including the flow to return from Step S80 to Step S25 corresponds to transition from the communication range 20C2 to the communication range 20C3 in FIG. 5.

At Step S70, if the duplicated obtainment ratio W is larger than the threshold value th, the determination is satisfied, and the CPU 4 considers that the communication power is too large and proceeds to Step S85. At Step S85, the CPU 4 decreases the communication power P only by ΔPd, which is a second power width. At Step S90, the CPU 4 outputs a signal to the display part 8 so as to have the display part 8 display and inform the user that the communication power P has been decreased and then, returns to Step S25 and repeats the similar procedures. That is, the control including the flow to return from Step S90 to Step S25 corresponds to transition from the communication range 20B2 to the communication range 20B3 in FIG. 4.

In the above, Step S50, Step S65, and Step S70 function as comparing means described in each claim and Step S5, Step S55, Step S75, and Step S85 function as communication control means.

As described above, in this embodiment, the user sequentially moves the communication range 20 of the reader 1, and the reader 1 reads information from the plurality of RFID tag circuit elements To. Then, on the basis of the obtainment result of the tag ID in the current communication range 20 and the obtainment result of the tag ID in the communication range 20 immediately before the movement and stored in the memory 6, the reader 1 calculates the duplicated obtainment ratio W of the tag ID and compares it with the predetermined threshold value th. This predetermined threshold value th is 0.25 in the above-described example. In the case of W<th, the reader 1 considers that there are few RFID tag circuit elements To whose tag IDs are redundantly obtained and the above-described communication range is relatively narrow. The communication range is the size of the communication range 20 in the moving direction. Then, the reader 1 increases the communication power P as illustrated in Step S75, for example. As a result, the communication range 20 is expanded, and the communication range is also expanded. In the case of W>th, it is regarded that there are many RFID tag circuit elements To whose tag IDs are redundantly obtained and the communication range is relatively wide, and the reader 1 decreases the communication power P at Step S85. As a result, the communication range 20 is reduced, and the communication range is also reduced.

As described above, in this embodiment, the communication range when the information is read from the plurality of RFID tag circuit elements To while moving can be set so as not to be too wide or too narrow but to an appropriate value. Therefore, while the latest communication status during movement is timely handled, and while missed transmission of a response request signal or missed reception of a response signal is prevented, wasting of power can be prevented. As a result, energy can be saved, a continuous operation time in battery driving, for example, can be prolonged, and convenience for the operator can be improved.

When information is to be read form the plurality of RFID tags T while moving, there can be a case in which the duplicated obtainment ratio W between the obtainment result of the current tag ID and the obtainment result of the previous tag ID is zero. In this case, it is likely that missed transmission of the response request signal or missed reception of the response signal occurs. Then, particularly in this embodiment, if it is W=0, the reader 1 sets the communication power P to the maximum value Pmax. As a result, the tag ID of the RFID tag T for which missed transmission or missed reception occurred can be reliably obtained.

In the above, at Step S50 in FIG. 7, the CPU 4 of the reader 1 maintains the communication power P at the same value if the duplicated obtainment ratio W is equal to the threshold value th, but this is not limiting. In the case of W=th, too, the CPU 4 may perform power-down only by ΔPd, which is the second power width, similarly to the case of W<th. In this case, at Step S70, it is only necessary that the CPU 4 determines whether or not it is W≧th.

With regard to Step S75 and Step S85, the magnitude of the decrease ΔPd of the communication power P may be the same as that of the increase ΔPu of the communication power P. However, the decrease of the communication power P is a communication power change in a direction to decrease duplicated obtainment of the tag ID obtained immediately before the tag ID obtained this time, and thus, the CPU 4 may decrease the communication power P by ΔPd, which is a value smaller than ΔPu little by little. As a result, an emphasis can be placed on prevention of occurrence of missed transmission of the response request signal or missed reception of the response signal, and the communication range can be gradually made smaller little by little so that they cannot occur. On the contrary, if an emphasis is placed on prevention of wasting of power, the increase ΔPu to increase the communication power may be set smaller than ΔPd to decrease the communication power. In this case, by gradually increasing the communication power little by little, wasting of power can be prevented.

Particularly in this embodiment, the display part 8 is disposed on the reader 1, and if the increase and decrease control of the communication power P is executed, the display part 8 informs the change corresponding to the increase and decrease control. As a result, the user can reliably recognize the fact that the communication range is controlled to be widened or narrowed by means of increase and decrease control of the communication power P according to the changing communication state.

The present invention is not limited to the above embodiment but is capable of various variations in a range without departing from the gist and technical idea thereof. The variations will be described below.

(1) If the Threshold Value th is Set on the Basis of the Directivity of the Reader Antenna 3:

Various antennas with different directivities can be used as the reader antenna 3 by replacement in some cases. In such a case, the threshold value th can be changed in accordance with the directivity.

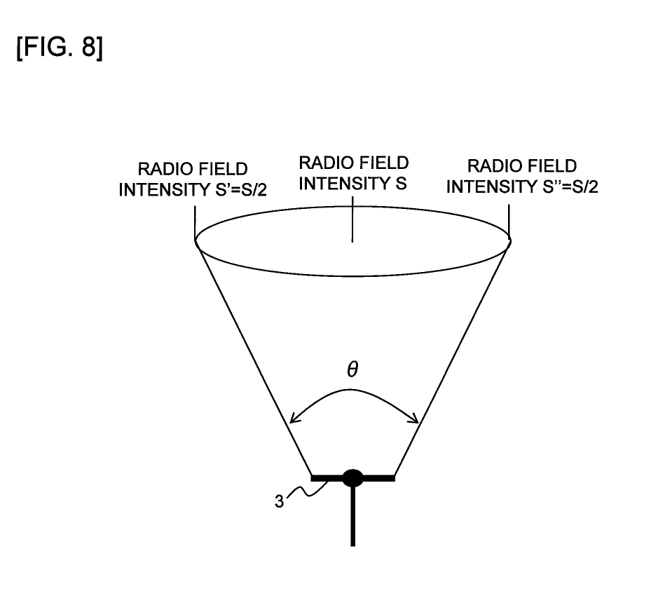

As an index of the directivity of the reader antenna 3, a half-band width θ as a directivity width illustrated in FIG. 8, for example, can be used. The half-band width θ is defined as an angle at which the electric field strength by power of the radio wave emitted from the reader antenna 3, that is, a radio field intensity S′ becomes a half of the radio field intensity S on the front of the reader antenna 3.

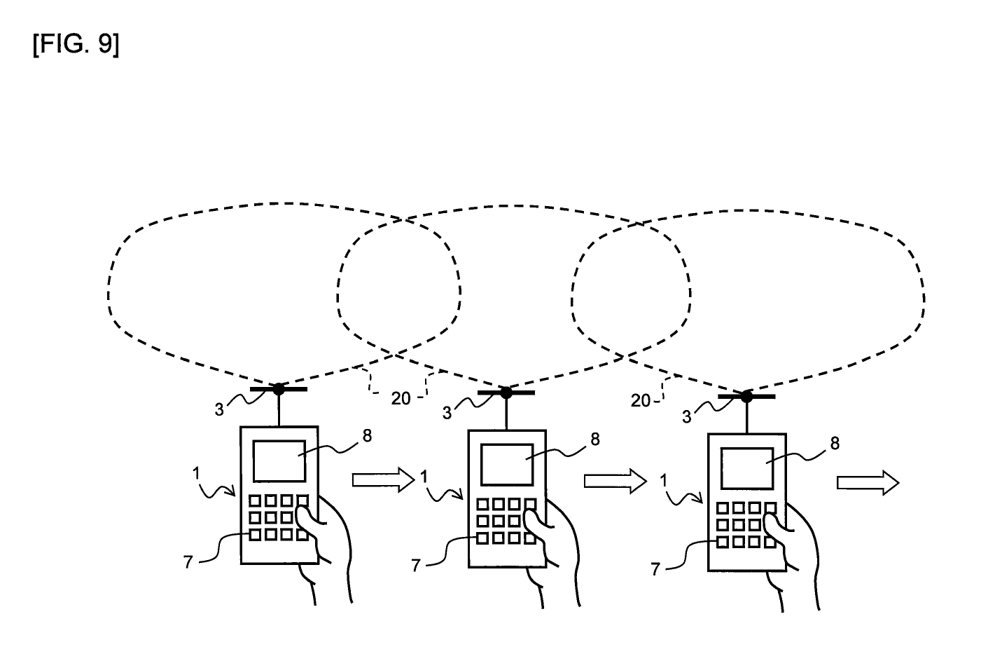

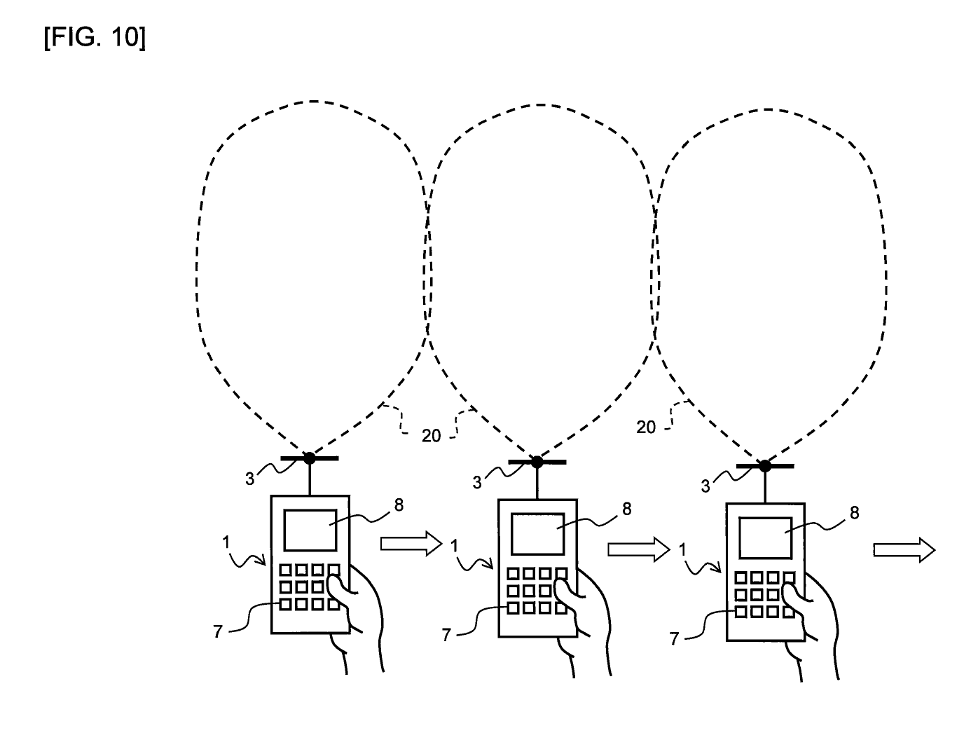

The half-band width θ of the reader antenna 3 influences the size of the communication range 20 formed by the reader antenna 3. For example, as illustrated in FIG. 9, if the half-band width θ of the reader antenna 3 is wide, the communication range becomes wide. In this case, even if the number of redundantly obtained tag IDs is set to a smaller value, it is less likely that missed transmission of the response request signal or missed reception of the response signal occurs. For example, as illustrated in FIG. 10, if the half-band width θ of the reader antenna 3 is narrow, the communication range becomes narrow. In this case, unless the number of redundantly obtained tag IDs is set to a larger value, it is highly likely that missed transmission of the response request signal or missed reception of the response signal occurs.

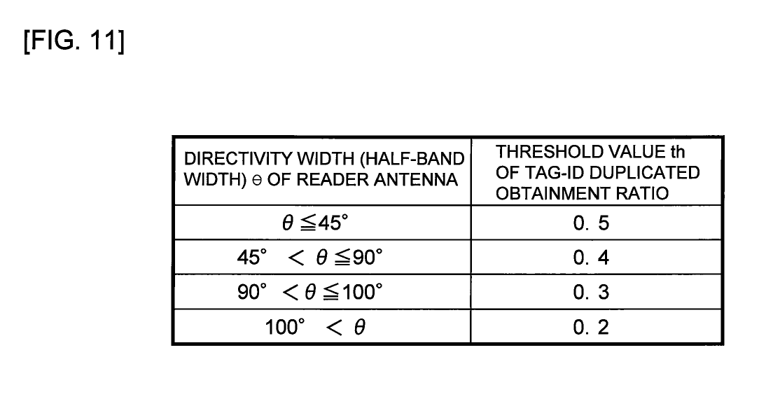

Thus, in this variation, in accordance with the size of the directivity width of the reader antenna 3 used in the reader 1, the threshold value th of the duplicated obtainment ratio W of the tag ID is changeably set. For example, in a table illustrated in FIG. 11, if the half-band width θ is 0° or more and 45° or less, it is th=0.5, if the half-band width θ exceeds 45° and 90° or less, it is th=0.4, if the half-band width θ exceeds 90° and 100° or less, it is th=0.3, and if the half-band width θ0 exceeds 100°, it is th=0.2. That is, it is set so that the smaller the half-band width θ of the reader antenna 3 is, the larger the threshold value th of the duplicated obtainment ratio of the tag ID becomes, and the larger the half-band width θ of the reader antenna 3 is, the smaller the threshold value th of the duplicated obtainment ratio of the tag ID becomes.

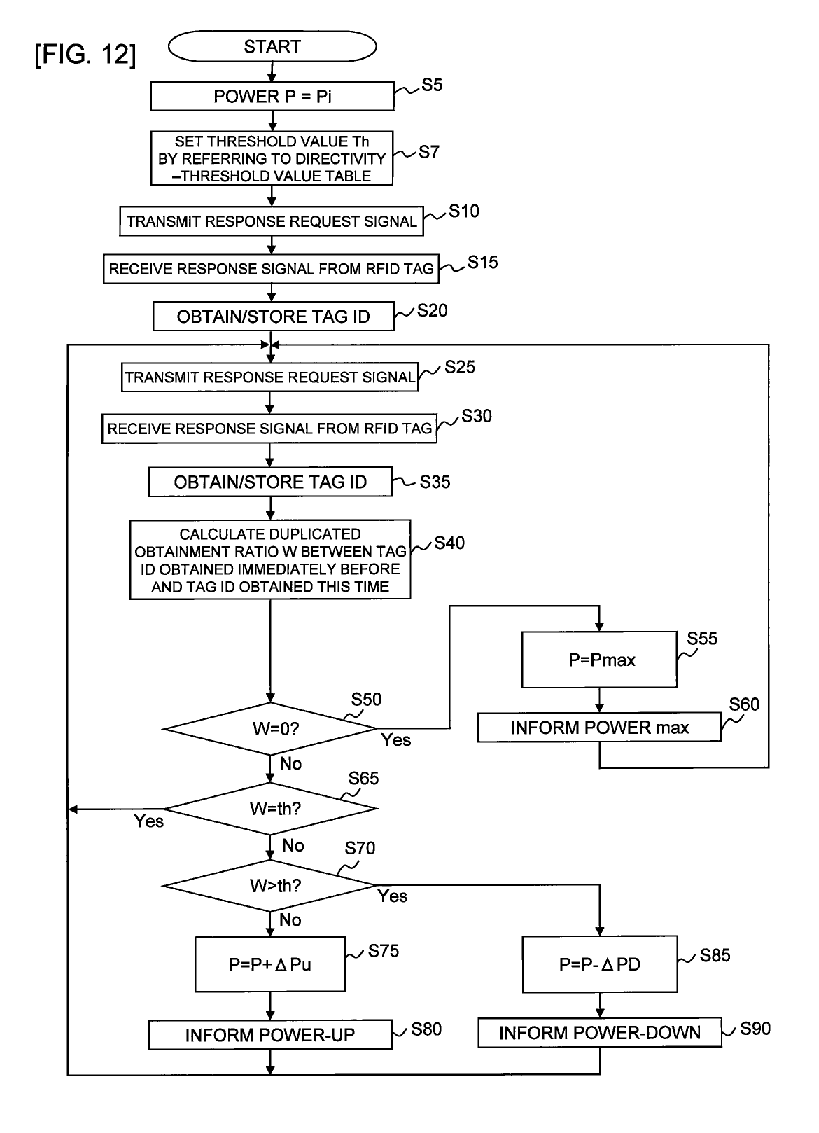

As illustrated in FIG. 12, in the control procedures executed by the CPU 4 of the reader 1 in this variation, Step S7 is added between Step S5 and Step S10 in the flow in FIG. 7.

That is, at Step S5, the CPU 4 sets the communication power P of the reader antenna 3 to the predetermined value Pi and then, proceeds to Step S7. At Step S7, the CPU 4 refers to the table illustrated in FIG. 11 and compares and determines the value of the half-band width θ of the reader antenna 3 and boundary values 45°, 90°, and 100° between sections in the table. This comparison and determination function at Step S7 functions as directivity determining means. Then, the CPU 4 sets the value of the threshold value th corresponding to the half-band width θ on the basis of the comparison and determination at Step S7. This threshold-value setting function at Step S7 functions as a first threshold value setting means. After that, the procedures are the same as those in FIG. 7, and at Step S65 and Step S70, the CPU 4 uses the threshold value th set at Step S7.

In this variation, in accordance with the directivity width of the reader antenna 3, the CPU 4 changes and sets the value of the threshold value th of the duplicated obtainment ratio of the tag ID. As a result, regardless of the directivity width of the reader antenna 3, occurrence of missed transmission of the response request signal or missed reception of the response signal can be prevented with higher accuracy.

(2) If the Threshold Value th is Changed in Accordance with Directivity Variable Control of the Reader Antenna 3:

For example, there can be a case in which a directivity control part 12 is disposed in the RF communication control part 10 in the main-body control part 2 illustrated in FIG. 2 and the directivity control part 12 executes variable control of the directivity of the reader antenna 3. In such a case, the CPU 4 refers to the table in FIG. 11 similarly to the variation in (1) and changes the threshold value th at any time.

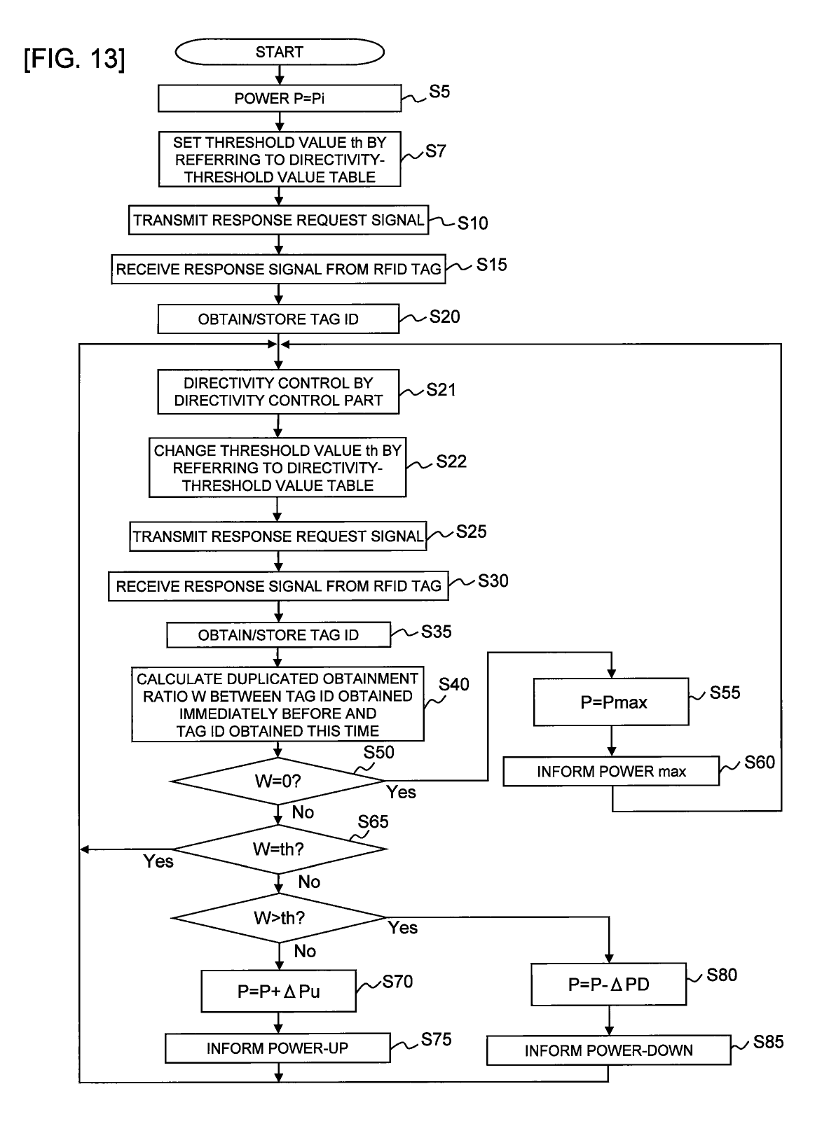

As illustrated in FIG. 13, in the control procedures executed by the CPU 4 of the reader 1 in this variation, new Step S21 and Step S22 are added between Step S20 and Step S25 in FIG. 12.

That is, similarly to FIG. 12, the CPU 4 initializes the threshold value th by referring to the table in FIG. 11 on the basis of the value of the half-band width θ corresponding to an initial value of the directivity of the reader antenna 3 variably controlled by the directivity control part 12 at Step S7.

The subsequent Step S10, Step S15, and Step S20 are the same as those in the flow in FIG. 12. Then, at Step S21, the CPU 4 controls and changes the directivity of the reader antenna 3 by means of control of the directivity control part 12. After that, at Step S22, the CPU 4 refers to the table in FIG. 11 and compares and determines the value of the half-band width θ of the reader antenna 3 at this time and the boundary values 45°, 90°, and 100° between sections in the table on the basis of the directivity of the reader antenna 3 changed by the directivity control part 12. This comparison and determination function by the CPU 4 functions as directivity determining means. The CPU 4 changes the value of the threshold value th corresponding to the half-band width θ on the basis of the comparison and determination. The subsequent Step S25 to Step S85 are the same as those in the flow in FIG. 12.

In the above, Step S7 and Step S22 function as first threshold value setting means described in each claim.

In this variation, even if the directivity of the reader antenna 3 is changed by the directivity control part 12 at any time, the CPU 4 can change and set the value of the threshold value th on the basis of the changed directivity. As a result, occurrence of missed transmission of the response request signal or missed reception of the response signal can be prevented with higher accuracy.

In the above description, the change control of the directivity of the reader antenna 3 by the directivity control part 12 is utilized only for the change of the threshold value th, but this is not limiting. That is, instead of increase and decrease control of the communication power as above as a method of changing the communication range of the reader antenna 3 by means of the control by the CPU 4, it may be set such that the directivity control part 12 changes the size of the directivity of the reader antenna 3. In this case, the directivity control part 12 functions as directivity control means as one function of the communication control means. In this case, the threshold value th may be fixed or may be variable by the above-described method. That is, if the duplicated obtainment ratio W is larger than the threshold value th, the CPU 4 considers that the communication range is wider than necessary, and the directivity control part 12 executes control such that the directivity of the reader antenna 3 is narrowed. On the contrary, if the duplicated obtainment ratio W is smaller than the threshold value th, the CPU 4 considers that the communication range is too narrow to prevent missed transmission or missed reception, and the directivity control part 12 executes control such that the directivity of the reader antenna 3 is widened. In this case, too, the same advantages as those in the embodiment can be obtained.

(3) If the Threshold Value th is Set in Accordance with the Number of the Currently Obtained Tag IDs:

When obtainment of the tag ID is performed by the reader 1, if the number of the currently obtained tag IDs is small, the number of the RFID tags T present in the communication range 20 of the reader antenna 3 is relatively small. In other words, the RFID tags T are arranged scarcely. Thus, when the obtainment of the tag IDs is performed by the reader 1 after that, unless the number of tag IDs of the RFID tag circuit elements To to be obtained redundantly is set larger, it is highly likely that missed transmission of the response request signal or missed reception of the response signal occurs. On the contrary, if the number of currently obtained tag IDs is large, the number of RFID tags T present in the communication range 20 of the reader antenna 3 is relatively large. In other words, the RFID tags T are closely arranged. Thus, when the obtainment of the tag IDs is performed by the reader 1 after that, even if the number of tag IDs of the RFID tag circuit elements To to be obtained redundantly is set smaller, it is less likely that missed transmission of the response request signal or missed reception of the response signal occurs. In this variation, in response to the above, the threshold value th to be used in the subsequent obtainment of the tag ID is changed in accordance with the number of the currently obtained tag IDs.

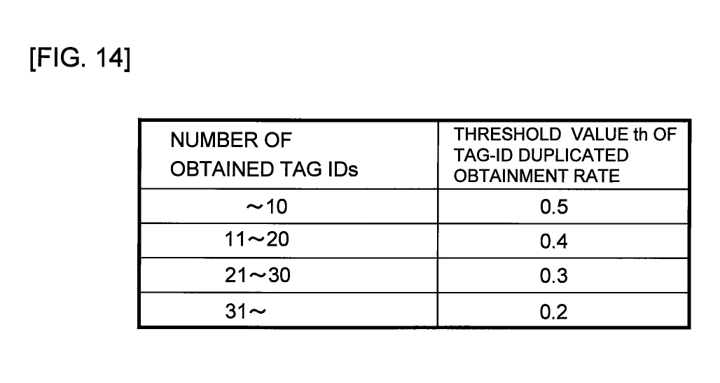

In this variation, in order to change the threshold value th, the table illustrated in FIG. 14 is used. As illustrated in the table, if the number of the read-out tag IDs is 10 or less, the value th to be used after that is 0.5, if the number of the read-out tag IDs is 11 or more and 20 or less, the value th to be used after that is 0.4, if the number of the read-out tag IDs is 21 or more and 30 or less, the value th to be used after that is 0.3, and if the number of the read-out tag IDs is 31 or more, the value th to be used after that is 0.2. That is, this table is defined such that the smaller the number of tag IDs obtained in reading of the tag information is, the larger the threshold value th of the duplicated obtainment ratio of the tag ID becomes, and the larger the number of the tag IDs obtained in reading of the tag information is, the smaller the threshold value th of the duplicated obtainment ratio of the tag ID becomes.

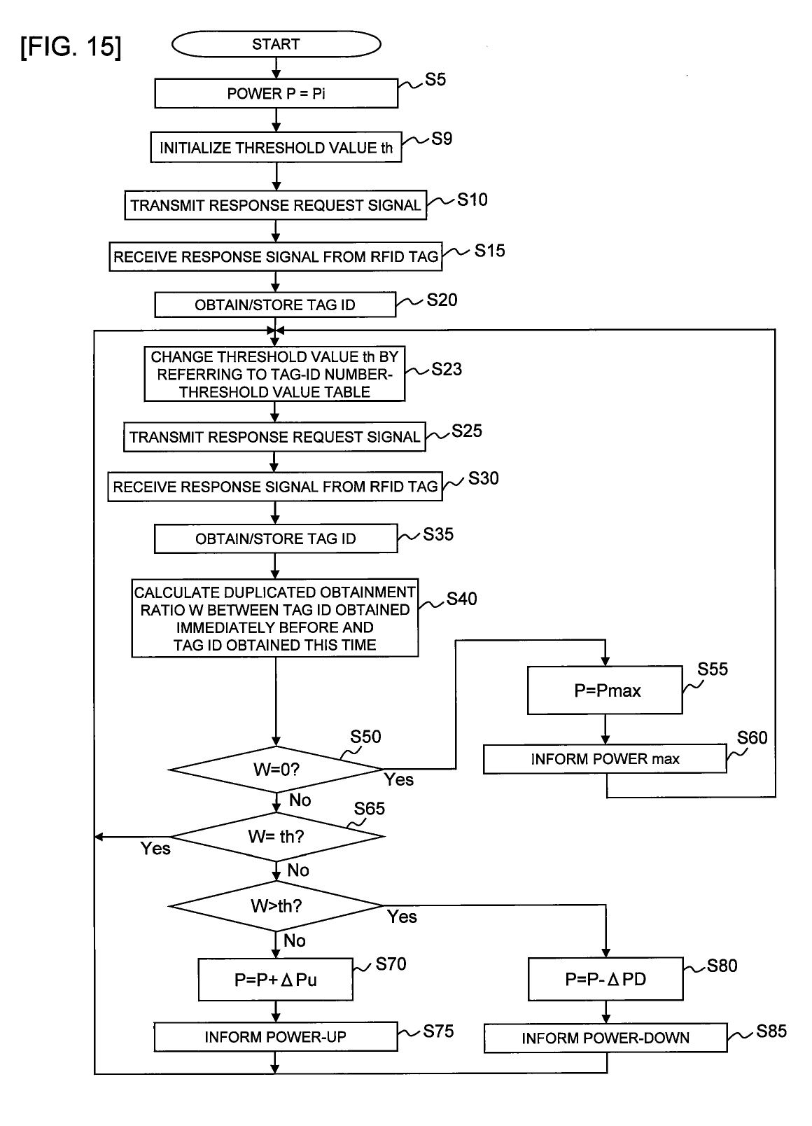

As illustrated in FIG. 15, in the control procedures executed by the CPU 4 of the reader 1 in this variation, Step S9 is provided instead of Step S7 in the flow of FIG. 13, and Step S23 is provided instead of Step S21 and Step S22.

That is, at Step S5, after the communication power P of the reader antenna 3 is set to the predetermined value Pi by means of control by the CPU 4, the routine proceeds to newly provided Step S9. At Step S9, the CPU 4 initializes the value of the threshold value th to an appropriate value.

The subsequent Step S10, Step S15, and Step S20 are the same as those in the flow of FIG. 13. Then, at Step S23, the CPU 4 compares the number of tag IDs obtained at Step S20 with the boundary values 10, 20, and 30 between sections in the table in FIG. 14 and makes determination. Alternatively, at Step S23, if the CPU 4 returns from Step S60, Step S80, and Step S90 to Step S25, the CPU 4 compares the number of the tag IDs obtained at Step S35 before the return with the boundary values 10, 20, and 30 between sections in the table in FIG. 14 and makes determination. This procedure by the CPU 4 functions as identification information determining means. Then, the CPU 4 changes and sets the value of the threshold value th in accordance with the above-described comparison and determination result. This procedure by the CPU 4 functions as second threshold value setting means. Step S25 to Step S85 are the same as those in the flow in FIG. 13. Step S23 may be provided between Step S35 and Step S40. In this case, the CPU 4 compares the number of tag IDs obtained at Step S35 with the boundary values between the sections in the table in FIG. 14 and makes determination and then, changes and sets the value of the threshold value th in accordance with the comparison and determination result.

In this variation, the reader 1 changes and sets the value of the threshold value th in accordance with the number of the currently obtained tag IDs. As a result, occurrence of missed transmission of the response request signal or missed reception of the response signal can be prevented with higher accuracy without depending on the quantity of the RFID tag circuit elements To present in the communication range 20 of the reader antenna 3.

(4) If Duplicated Obtainment of the Tag ID Occurs between the Vertically Adjacent Communication Ranges 20 of the Reader Antenna 3:

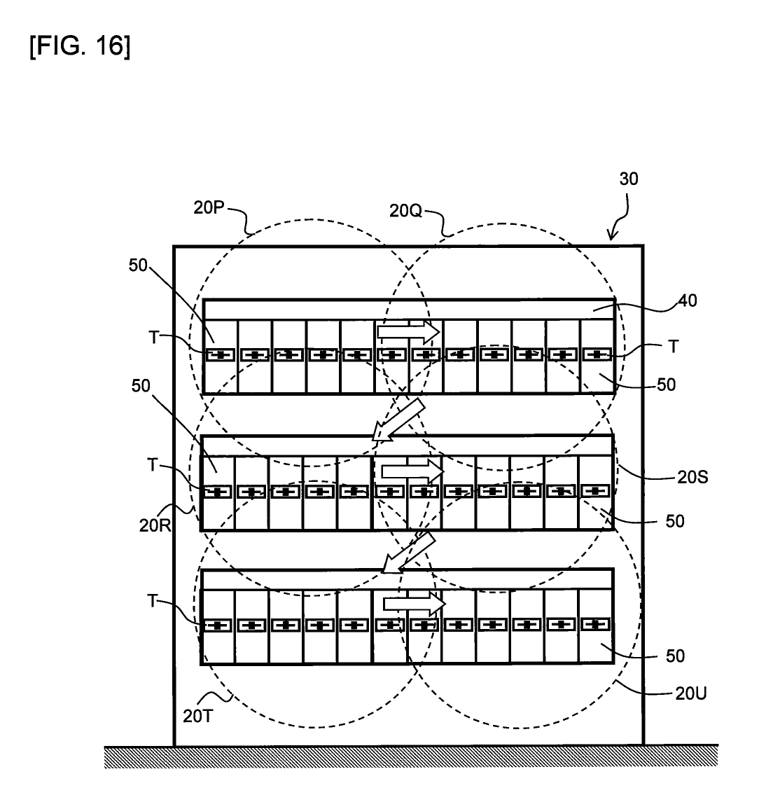

In the above, the example in which the communication ranges 20 of the sequentially moving reader antenna 3 are overlapped in the lateral direction due to the lateral movement, that is, the movement in the right and left direction of the reader 1 is described, but this is not limiting. For example, as illustrated in FIG. 16, if the articles B to which the RFID tags T are attached are files or the like and stored in plural vertical shelves in a cabinet, duplicated obtainment of the tag ID also occurs in the vertically adjacent communication ranges 20.

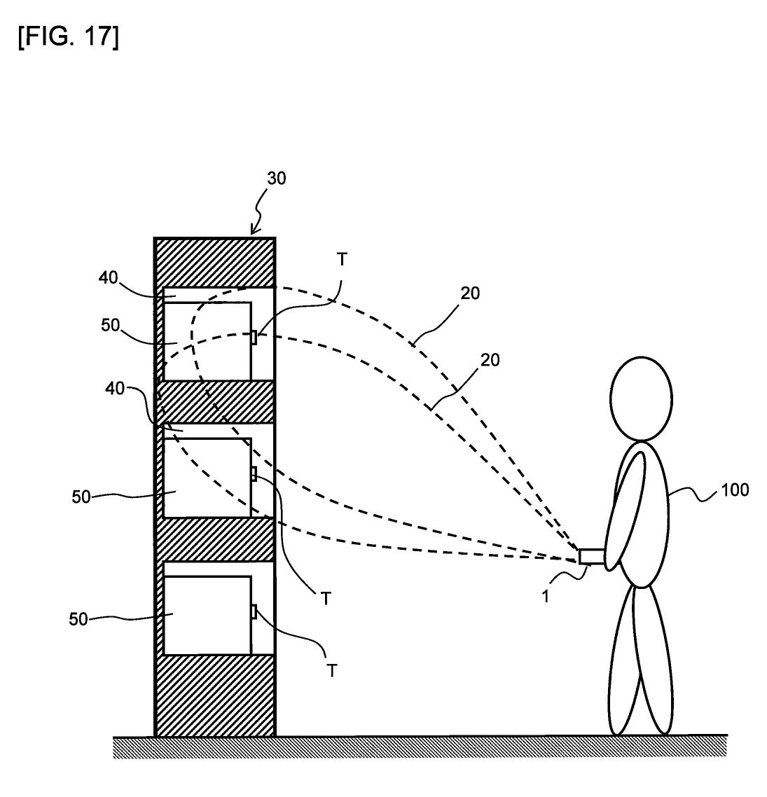

In the example in FIG. 16, three stages of recess-shaped storage portions 40 are vertically disposed in a cabinet 30. In each storage portion 40, a plurality of files 50 with their spines to which the RFID tags T are attached, respectively, faced front are stored in a lateral row. To the cabinet 30, as illustrated in FIG. 17, the reader 1 held by a user 100 performs information reading from the RFID tag circuit element To of the RFID tag T on each file 50 and obtains tag ID. At this time, the user 1 sequentially moves the communication range of the reader 1 in a zigzagged manner in each of the storage portions 40 in upper, middle, and lower stages of the cabinet 30 in the order of a communication range 20P, a communication range 20Q, a communication range 20R, a communication range 20S, a communication range 20T, and a communication range 20U as indicated by white arrows in FIG. 16.

For example, it is assumed that the reader 1 is in a state in which it has obtained the tag IDs of a plurality of the RFID tags T in the communication range 20R located on the left part of the storage portion 40 in the middle stage at present. In the current communication range 20R, the RFID tag T located also in the communication range 20P in the left part of the storage portion 40 in the upper stage is present. Thus, with regard to the RFID tag T, in addition to the tag ID obtained in the communication range 20P, the tag ID is also redundantly obtained in the current communication range 20R. Therefore, in such a case, the CPU 4 calculates the duplicated obtainment ratio not with the tag ID obtained in the obtainment immediately before as described above but the obtainment result of all the tag IDs obtained in all the obtainments before and compares the result with the separately set threshold value th. In this case, too, the advantages similar to those in the embodiments and variations (1), (2), and (3) can be obtained.

What is claimed is:

1. An apparatus for communicating with a radio frequency identification (RFID) tag configured to perform radio communication with an RFID tag circuit element having an IC circuit part that stores information and a tag antenna that performs information transmission and reception, the apparatus comprising:
an apparatus antenna configured to form a communication range where a radio communication is able to be performed and performs radio communication with said RFID tag circuit element located in said communication range;
a signal transmitting portion configured to transmit a response request signal to said RFID tag circuit element by said apparatus antenna;
an information obtainment portion configured to obtain tag identification information stored in said IC circuit part of said RFID tag circuit element from a response signal transmitted from said RFID tag circuit element in response to said response request signal and received by said apparatus antenna;
an identification information storage portion configured to store said tag identification information obtained by said information obtainment portion;
a calculation portion configured to calculate a duplicated obtainment ratio by the number of redundantly obtained pieces of information of a current obtainment result of said tag identification information by said information obtainment portion to a past obtainment result of said tag identification information stored in said identification information storage portion and by said obtainment result;
a comparison portion configured to compare said duplicated obtainment ratio calculated by said calculation portion with a threshold value for comparison; and
a communication control portion configured to execute communication control of widening a communication range of said apparatus antenna in at least the case that said duplicated obtainment ratio is less than said threshold value for comparison and of narrowing the communication range of said apparatus antenna in at least the case that said duplicated obtainment ratio exceeds said threshold value for comparison on the basis of a comparison result by said comparison portion.

2. The apparatus according to claim 1, wherein:
said identification information storage portion stores said obtainment result at every obtainment by said information obtainment portion corresponding to one transmission of said response request signal; and
said calculation portion calculates said duplicated obtainment ratio by the number of redundantly obtained pieces of information of a current obtainment result of said tag identification information by said information obtainment portion to an obtainment result which is obtained one time before current obtainment and stored in said identification information storage portion and by said current obtainment result of said tag identification information by said information obtainment portion.

3. The apparatus according to claim 1, wherein:
directivity of said apparatus antenna is configured variably; and
the apparatus further comprises:
a directivity determining portion configured to determine whether a directivity width of said apparatus antenna is narrow or wide with respect to a predetermined directivity width and
a first threshold value setting portion configured to set said threshold value for comparison to a large value if the directivity width of said apparatus antenna is determined to be narrow by said directivity determining portion and to set said threshold value for comparison to a small value if the directivity width of said apparatus antenna is determined to be wide by said directivity determining portion.

4. The apparatus according to claim 1, further comprising:
an identification information determining portion configured to determine if the number of pieces of said tag identification information obtained by said information obtainment portion in a current obtainment is smaller or larger than a predetermined number of pieces of tag identification information; and
a second threshold value setting portion configured to set said threshold value for comparison larger if the number of pieces of said tag identification information obtained by said information obtainment portion in said current obtainment is determined to be small by said identification information determining portion and to set said threshold value for comparison smaller if the number of pieces of said tag identification information obtained by said information obtainment portion in said current obtainment is determined to be large by said identification information determining portion.

5. The apparatus according to claim 1, wherein:
said communication control portion sets a communication power radiated from said apparatus antenna to a maximum power value in said apparatus if said duplicated obtainment ratio is zero on the basis of a comparison result by said comparison portion.

6. The apparatus according to claim 1, wherein:
said communication control portion increases a communication power radiated from said apparatus antenna by a predetermined first power width if said duplicated obtainment ratio is less than said threshold value for comparison and decreases a communication power radiated from said apparatus antenna by a second power width different from said first power width if said duplicated obtainment ratio is not less than said threshold value for comparison on the basis of a comparison result by said comparison portion.

7. The apparatus according to claim 1, further comprising
an informing portion configured to give a corresponding change information if control of said communication range is executed by said communication control portion.
